(19) United States
(12) Patent Application Publication
(10) Pub. No.: US 2012/0087079 A1
(43) Pub. Date: Apr. 12, 2012

(54) STORAGE CARD DEVICE OF A TYPE OF NECKLACE PENDANT WITH A SLIDING BUCKLE

(76) Inventor: Shao-Chieh TING, BanChiau City (TW)

(21) Appl. No.: 12/899,988

(22) Filed: Oct. 7, 2010

(51) Int. Cl. G06F 1/16

(52) U.S. Cl. 361/679.32

(57) ABSTRACT

A storage card device of a type of necklace pendant with a sliding buckle, includes an upper cover, a lower cover, a USB storage card, a storage card fixing rack, a rectangular decorative crystal and plural decorative diamonds. The USB storage card can be connected with a computer to transmit data. The USB storage card and the fixing rack thereof are put between the upper and lower covers which are all provided with chutes allowing the fixing rack to slide. The storage card device of a type of necklace pendant with a sliding buckle, according to the present invention, is sophisticate, can assure that the USB storage card will not be damaged and can be easily carried personally at a same time, as well as is able to completely remove a user from being afraid that the USB storage card may be missing.

### BACKGROUND OF THE INVENTION

a) Field of the Invention

The present invention relates to a storage card device, and more particularly to a storage card device of a type of necklace pendant with a sliding buckle, which, through providing a spring clamp on a storage card fixing rack, is easy to be taken down for use when being used and is stably fixed on the necklace without falling off when being collected.

b) Description of the Prior Art

As rapid development of electronic and information industries, various new electronic and information products keep showing up on markets. In addition to that the products are designed toward multi-purpose and multi-function, one must pursue a design of small size and light weight that a user can carry and use easily and no matter for a desktop computer or a portable computer, the size of the product is much smaller than it was. Accordingly, all kinds of peripheral electronic products should be designed more toward facilitating the user to carry and use; whereas, in terms of a digital storage device which is used most frequently, the object of operation can be achieved only by interconnecting the digital storage device with a corresponding connector of computer.

For a necklace card reader or digital storage device used on the existing markets, in terms of connecting a cover with a main body, a tight fitting method is commonly used for the cover and a USB (Universal Serial Bus) connector of the main body. On the other hand, an elastic plastic hook can be used, as well. However, for the abovementioned two methods, due to multiple times of use and collection, tightening positions between the cover and the main body can be worn out, causing the cover or the main body to fall off. Moreover, as being provided on the necklace, when the card reader or a main body of the digital storage device is to be used, the necklace has to be taken down and this method is even more inconvenient during operation, which is rather unfortunate.

Accordingly, the abovementioned prior art is still provided with a lot of shortcomings and is indeed not a perfect design, thus requiring improvement.

### SUMMARY OF THE INVENTION

A storage card device of a type of necklace pendant with a sliding buckle, according to the present invention, includes a USB storage card, a storage card fixing rack, an upper cover, a lower cover and a crystal ornament. The storage card fixing rack is provided with a spring clamp through which the storage card and the fixing rack can slide and be fixed in chutes provided by the upper and lower covers, thereby achieving the objects of using and collecting the storage card device.

The primary object of the present invention is to provide a storage card device of a type of necklace pendant with a sliding buckle, which is sophisticate and convenient, can be carried personally, serves as a necklace pendant while is also a storage device.

Another object of the present invention is to provide a storage card device of a type of necklace pendant with a sliding buckle, wherein the storage card device is provided on a necklace such that when the storage card is to be used, one only needs to remove the storage card device from the necklace directly without a need to take down the necklace altogether.

Still another object of the present invention is to provide a storage card device of a type of necklace pendant with a sliding buckle, wherein the storage card fixing rack is provided with the spring clamp through which the user can conveniently take down the storage card device for use as well as collect and fix the storage card device. In addition, a risk of missing the USB storage card can be even avoided.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional exploded view of a storage card device of a type of necklace pendant with a sliding buckle, according to the present invention.

FIG. 2 shows another three-dimensional exploded view of the storage card device of a type of necklace pendant with a sliding buckle, according to the present invention.

FIG. 3A and FIG. 3B show schematic views of the storage card device of a type of necklace pendant with a sliding buckle, which is collected, according to present invention.

FIG. 4A and FIG. 4B show three-dimensional schematic views of the storage card device of a type of necklace pendant with a sliding buckle, which is used, according to the present invention.

FIG. 5 shows a schematic view of an implementation operation of the storage card device of a type of necklace pendant with a sliding buckle, according to the present invention.

FIG. 6A and FIG. 6B show three-dimensional schematic views of a second embodiment of the storage card device which is collected, according to the present invention.

FIG. 7 and FIG. 8 show three-dimensional exploded views of the second embodiment of the storage card device, according to the present invention.

FIG. 9 shows a schematic view of an implementation operation of the second embodiment of the storage card device, according to the present invention.

### DETAILED DESCRIPTION OF THE PREFERRED EMBODIMENTS

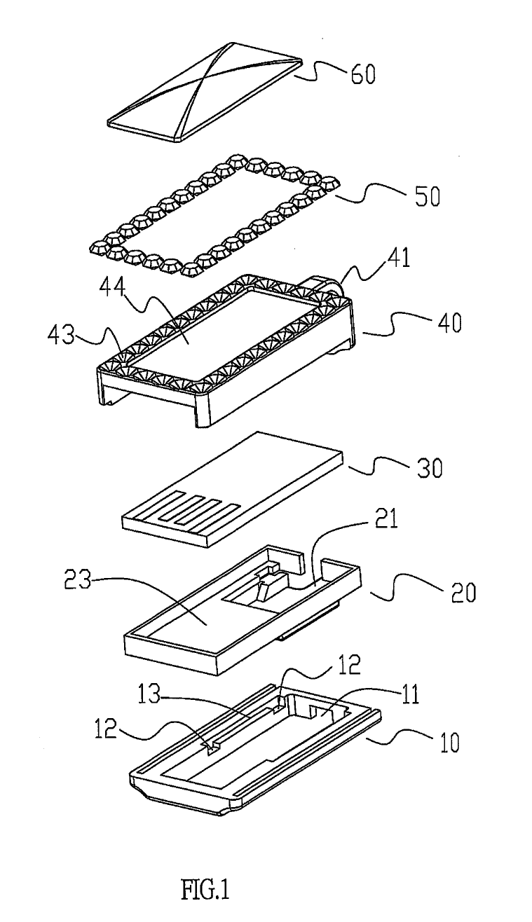

Referring to FIG. 1, a storage card device of a type of necklace pendant with a sliding buckle, according to the present invention, comprises primarily a lower cover 10, a storage card fixing rack 20, a USB storage card 30, an upper cover 40, plural decorative diamonds 50 and a rectangular decorative crystal 60.

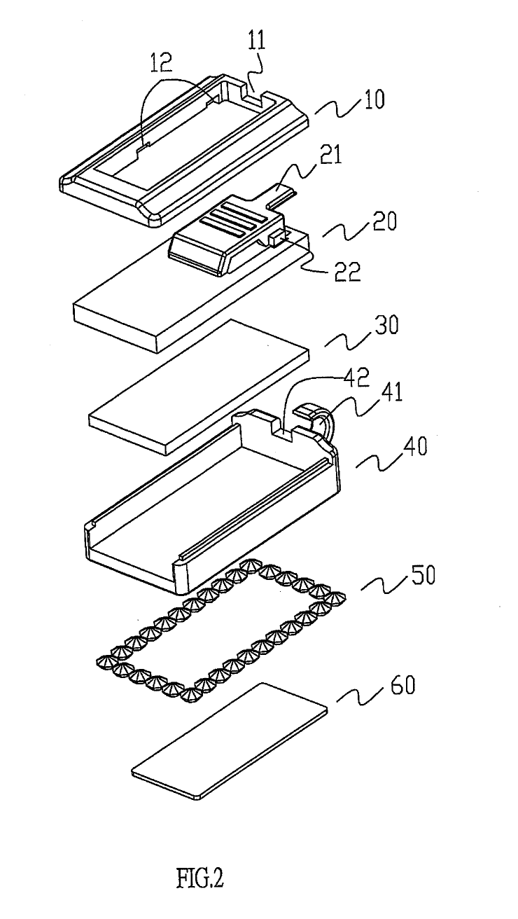

Referring to FIG. 2 at a same time, the lower cover 10 is provided with a spring clamp yielding slot 11 and two inner sides are both provided with positioning grooves 12 and chutes 13.

The storage card fixing rack 20 is provided with a fixing rack spring clamp 21, two sides of which are all provided with a spring clamp bump 22 which can slide and be positioned in the chute 13 of the lower cover 10. In addition, the storage card fixing rack 20 is also provided with a USB storage card holding slot 23.

The upper cover 40 is provided with a shackle 41 for assembling a necklace or a sling, a spring clamp yielding slot 42, plural decorative diamond fixing slots 43 and a rectangular decorative crystal holding slot 44.

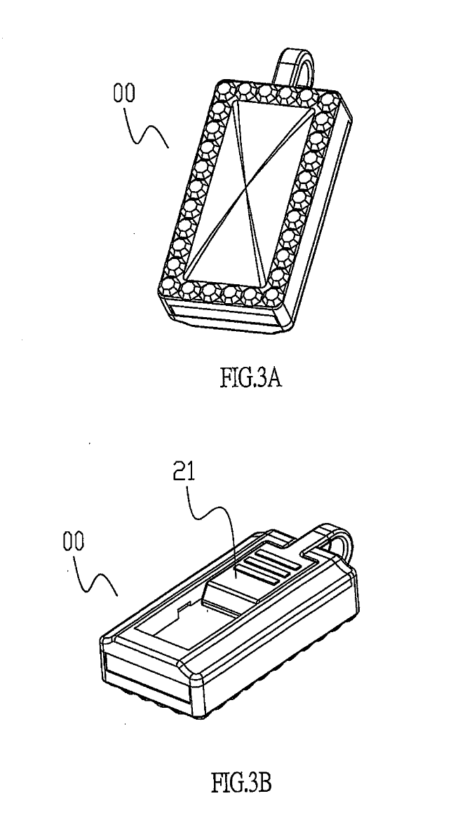

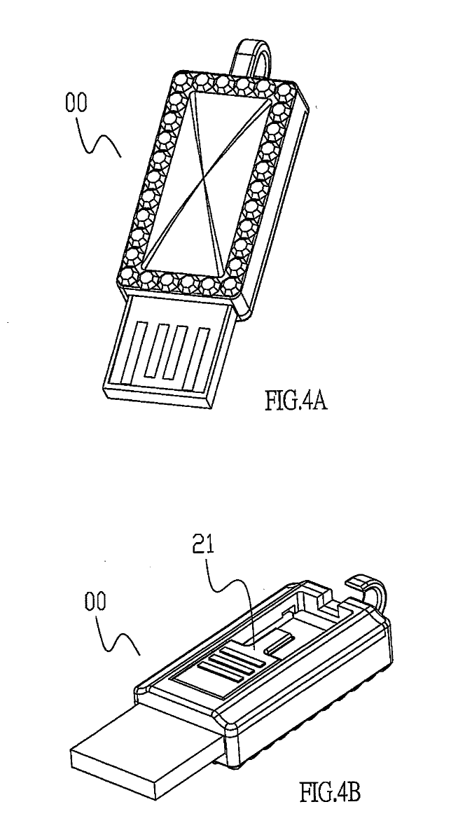

By the abovementioned structures, finished products of the present invention can be assembled, as shown in FIG. 3A and FIG. 3B. On the other hand, as shown in FIG. 4A and FIG. 4B, by sliding of the fixing rack spring clamp 21, a state of collection as shown in FIG. 3A and FIG. 3B or a state of use as shown in FIG. 4A and FIG. 4B can be formed.

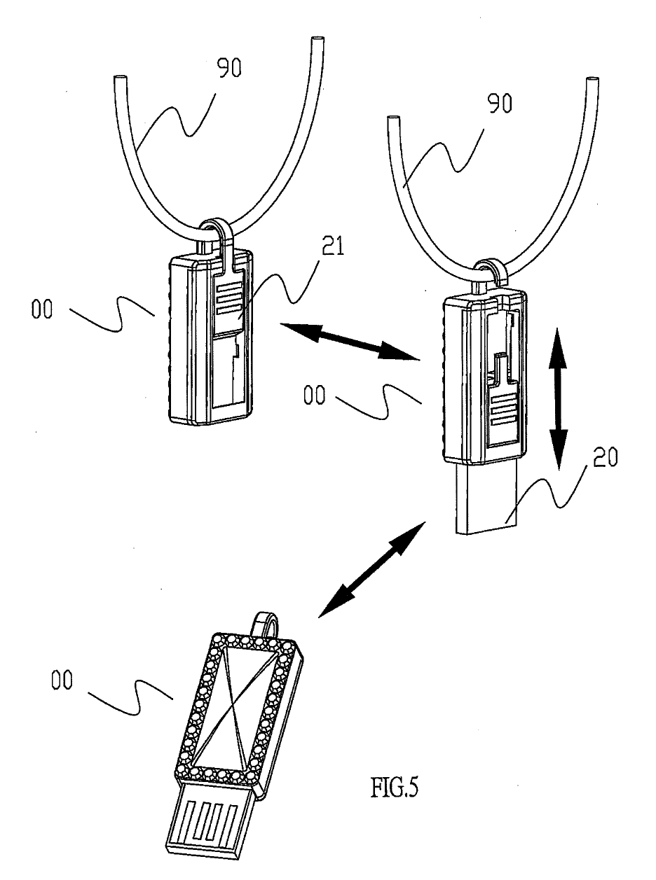

Referring to FIG. 5, it shows a schematic view of a storage card device 00 of the present invention, which is used and is collected. Through pressing down and pushing the fixing rack spring clamp 21 on the storage card fixing rack 20, the necklace or a sling 90 can also get loose at a same time when the USB storage card is pushed out. Moreover, if the fixing rack 20 is pushed back again at a same time when the spring clamp 21 is pressed down, then the storage card device 00 can be collected into the necklace or the sling 90.

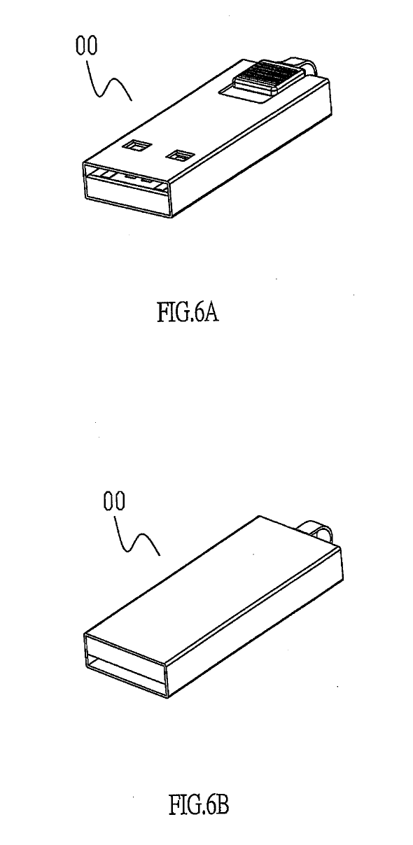

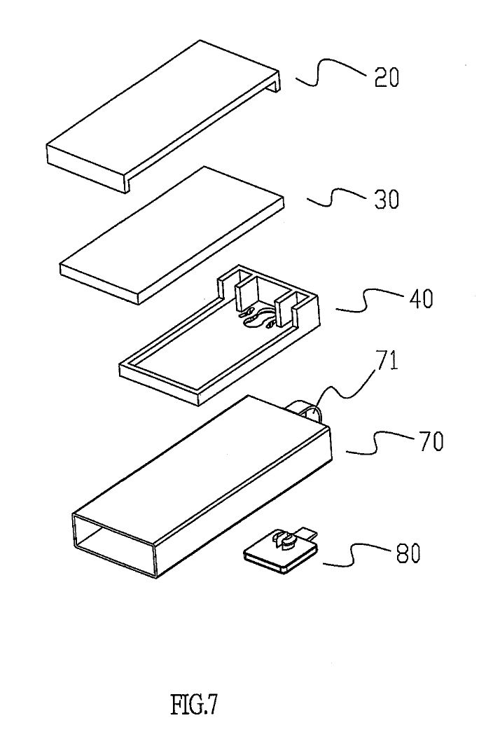

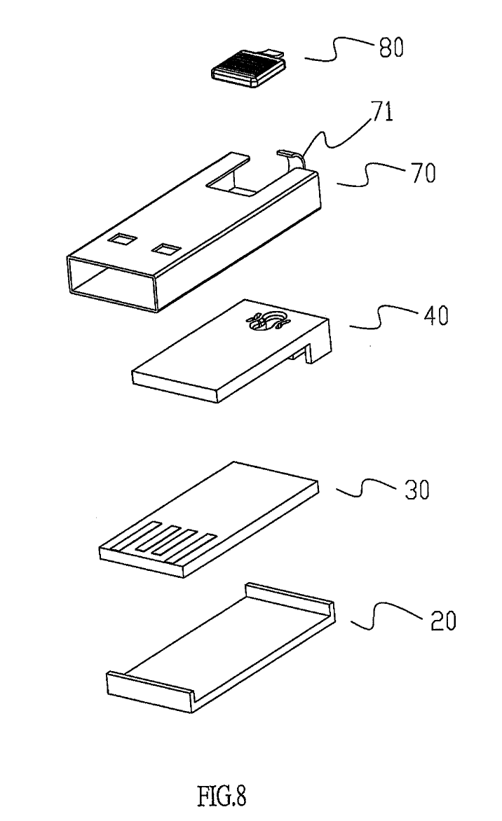

Referring to FIGS. 6A to 9, it shows a second embodiment of the present invention, wherein FIG. 6A and FIG. 6B are three-dimensional schematic views of the second embodiment of the storage card device 00, whereas FIG. 7 and FIG. 8 are three-dimensional exploded views of the second embodiment. As shown in the drawings, the present invention is formed primarily by a storage card fixing rack 20, a USB storage card 30, an upper cover 40, a USB casing 70 and a sliding buckle 80.

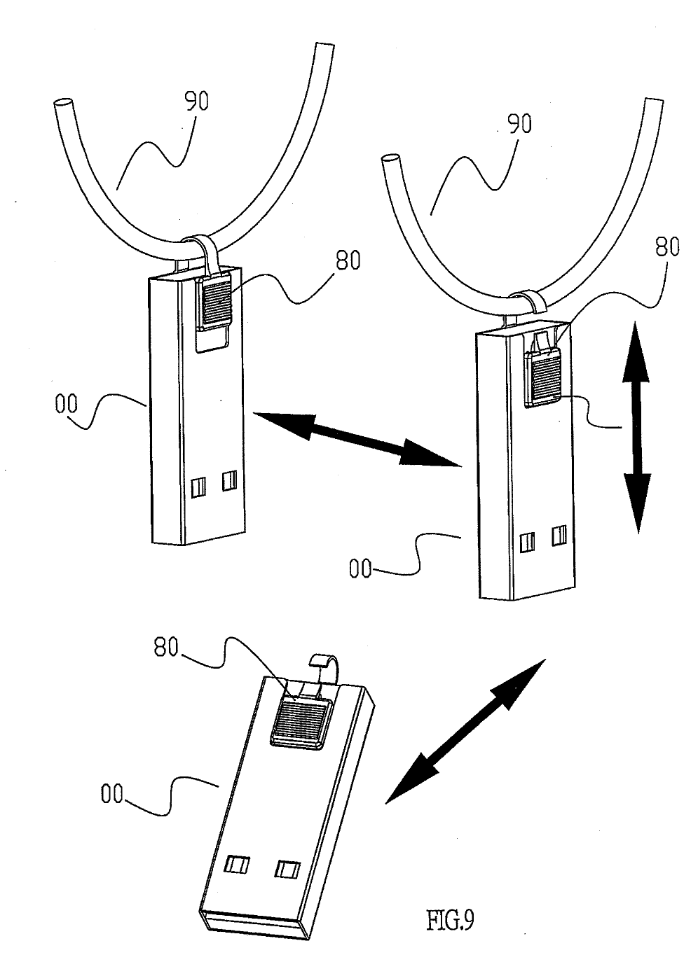

The USB casing 70 is provided with a shackle 71 for assembling the necklace or the sling. The shackle 71 is used in association with the sliding buckle 80 to facilitate taking down the storage card device from the necklace or the sling 90 for use, or collecting the storage card device into the necklace or the sling 90, as shown in FIG. 9.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A storage card device of a type of necklace pendant with a sliding buckle, comprising:
an upper cover, peripheries above which are framed with crystal fixing slots to embed plural crystals and a center of which is formed with a rectangular crystal holding slot to put a rectangular crystal;
a lower cover, a front end of which is provided with a fixing rack spring clamp yielding slot and two inner sides of which are both provided with a positioning groove and a chute;
a USB (Universal Serial Bus) storage card which is put in a storage card fixing rack; and
the storage card fixing rack which is used to put the USB storage card and a front end of which is provided with a fixing rack spring clamp.

2. The storage card device of a type of necklace pendant with a sliding buckle according to claim 1, wherein the storage card device is put on a necklace or a sling.

3. The storage card device of a type of necklace pendant with a sliding buckle according to claim 1, wherein the storage card device is provided with a fixing rack spring clamp or a sliding buckle, allowing the storage card device to be easily taken down from a necklace or a sling for use, and collected into the necklace or the sling for fixing.
